(19) United States
(12) Patent Application Publication
(10) Pub. No.: US 2017/0359271 A1
(43) Pub. Date: Dec. 14, 2017

(54) MULTI-TENANT BASED SYSTEM AND METHOD FOR PROVIDING SERVICES

(71) Applicant: SAMSUNG SDS CO., LTD., Seoul (KR)

(72) Inventors: Kwang-Hyun KOH, Seoul (KR); Seog-Joon LEE, Seoul (KR); Ji-Hun CHO, Seoul (KR); Sung-Jin PARK, Seoul (KR)

(73) Assignee: SAMSUNG SDS CO., LTD., Seoul (KR)

(21) Appl. No.: 15/616,492

(22) Filed: Jun. 7, 2017

(30) Foreign Application Priority Data
Jun. 10, 2016 (KR) 10-2016-0072391

(51) Int. Cl. H04L 12/911; H04L 12/26; H04L 12/24; H04L 29/08

(52) U.S. Cl. CPC H04L 47/70; H04L 41/0654; H04L 43/0876; H04L 67/10

(57) ABSTRACT

Disclosed are a multi-tenant-based service provision system and method. The multi-tenant-based service provision system includes a usage amount measurer configured to measure a resource usage amount of a service provided for each of a plurality of tenants in a cloud environment, a usage amount predictor configured to analyze the measured resource usage amount and predict a necessary resource usage amount, and a container controller having a plurality of container images each including information regarding an available resource allocation amount, the container controller being configured to distribute container images for executing the service to the cloud environment or collect the container images distributed to the cloud environment according to a result of the prediction.

### CROSS-REFERENCE TO RELATED APPLICATION

This application claims priority to and the benefit of Korean Patent Application No. 10-2016-0072391, filed on Jun. 10, 2016, the disclosure of which is incorporated herein by reference in its entirety.

### BACKGROUND

### 1. Field

Embodiments of the present disclosure relate to a technique for efficiently operating a multi-tenant-based service provision system.

### 2. Discussion of Related Art

A multi-tenant system is a system for simultaneously providing a service to a plurality of tenants. A multi-tenant system can increase resource usage efficiency by a plurality of tenants sharing resources.

However, a multi-tenant system has problem of resource competition between tenants and vulnerability in terms of handling a failure occurring in a system because each of the plurality of tenants receive a service from a single system. For example, according to a conventional multi-tenant system, resources of the system may be monopolized by a specific tenant, and a failure occurring in the system may influence all tenants associated with the system. Accordingly, a solution to efficiently distribute resources in a multi-tenant system, enhance quality of a provided service, and reinforce a failure tolerance function is needed.

### SUMMARY

Embodiments of the present disclosure provide enhancing service quality and efficiently distributing resources of a multi-tenant-based service provision system by using a container.

Embodiments of the present disclosure also provide reinforcing a fault tolerance function of a multi-tenant-based service provision system by using a container.

According to an aspect of the present disclosure, there is provided a multi-tenant-based service provision system including a usage amount measurer configured to measure a resource usage amount of a service provided for each of a plurality of tenants in a cloud environment; a usage amount predictor configured to analyze the measured resource usage amount and predict a necessary resource usage amount; and a container controller configured to distribute container images for executing the service to the cloud environment or collect container images distributed to the cloud environment according to a result of the prediction, the container controller having a plurality of container images each including information regarding an available resource allocation amount.

The container controller may distribute the container images to the cloud environment when a sum of resource allocation amounts of the container images distributed to the cloud environment is smaller than the predicted resource usage amount.

The container controller may distribute the container images to the cloud environment on the basis of the number of container images associated with a resource requirement amount needed for the cloud environment when a sum of resource allocation amounts of the container images distributed to the cloud environment is smaller than the predicted resource usage amount.

The multi-tenant-based service provision system may further include a gateway configured to receive requests for the service from the plurality of tenants and route the received requests to a container corresponding to the service in the cloud environment.

The gateway may determine that a fault has occurred and may stop the routing when the number of the received requests for the service exceeds a predetermined value.

The gateway may delay processing the requested service when a sum of resource allocation amounts of the container images distributed to the cloud environment is smaller than the predicted resource usage amount.

The usage amount predictor may analyze a pattern of the resource usage amount from a resource usage amount measured during a predetermined period of time, and the container controller may distribute the container images to the cloud environment or collect the container images distributed to the cloud environment according to the pattern analyzed during the period of time.

According to another aspect of the present disclosure, there is provided a multi-tenant-based service provision method performed by a service including one or more processors and a memory configured to store one or more programs executed by the one or more processors, the multi-tenant-based service provision method including measuring a resource usage amount of a service provided for each of a plurality of tenants in a cloud environment; analyzing the measured resource usage amount and predicting a necessary resource usage amount; and distributing container images for executing the service to the cloud environment or collecting container images distributed to the cloud environment according to a result of the prediction, wherein the plurality of containers have a plurality of container images, each including information regarding an available resource allocation amount.

The distributing or collecting of container images may include distributing the container images to the cloud environment when a sum of resource allocation amounts of the container images distributed to the cloud environment is smaller than the predicted resource usage amount.

The distributing or collecting of container images may include distributing the container images to the cloud environment on the basis of the number of container images associated with a resource requirement amount needed for the cloud environment when a sum of resource allocation amounts of the container images distributed to the cloud environment is smaller than the predicted resource usage amount.

The multi-tenant-based service provision method may further include receiving requests for the service from the plurality of tenants and routing the received requests to a container corresponding to the service in the cloud environment before measuring a resource usage amount.

The routing may include determining that a fault has occurred and stopping the routing when the number of the received requests for the service exceeds a predetermined value.

The routing may delay processing the requested service when the sum of resource allocation amounts of the container images distributed to the cloud environment is smaller than the predicted resource usage amount.

The predicting may include analyzing a pattern of the resource usage amount from a resource usage amount measured during a predetermined period of time, and the distributing or collecting of container images may include distributing the container images to the cloud environment or collecting the container images distributed to the cloud environment according to the pattern analyzed during the period of time.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a block diagram showing a detailed configuration of a multi-tenant-based service provision system according to an embodiment of the present disclosure;

FIG. 2 is an example diagram showing a structure of a cloud environment according to an embodiment of the present disclosure;

FIG. 3 is an example graph of a resource usage amount measured by a usage amount measurer according to an embodiment of the present disclosure;

FIG. 4 is a graph showing an example pattern of a measured resource usage amount according to an embodiment of the present disclosure;

FIG. 5 is a flowchart illustrating a multi-tenant-based service provision method according to an embodiment of the present disclosure; and

FIG. 6 is a block diagram illustrating a computing environment including a computing apparatus that is suitable to be used according to example embodiments.

### DETAILED DESCRIPTION OF EXEMPLARY EMBODIMENTS

Hereinafter, embodiments of the present disclosure will be described in detail with reference to the accompanying drawings. The following detailed description is provided to assist the reader in gaining a comprehensive understanding of the methods, apparatuses, and/or systems described herein. However, the description is only an example, and the present disclosure is not limited thereto.

In descriptions of embodiments of the present disclosure, when it is determined that a detailed description of a known technique associated with the present disclosure would unnecessarily obscure the subject matter of the present disclosure, the detailed description thereof will be omitted. Also, terms used herein are defined in consideration of the functions of the present disclosure and may be changed depending on a user, an intent of an operator, or a custom. Accordingly, the terms should be defined on the basis of the following overall description of this specification. The terminology used herein is only for the purpose of describing embodiments of the present disclosure and is not restrictive. The singular forms “a,” “an,” and “the” are intended to include the plural forms as well, unless the context clearly indicates otherwise. It should be understood that the terms “comprises,” “comprising,” “includes,” and/or “including” specify the presence of stated features, integers, steps, operations, elements, and/or components when used herein, but do not preclude the presence or addition of one or more other features, integers, steps, operations, elements, components, and/or groups thereof.

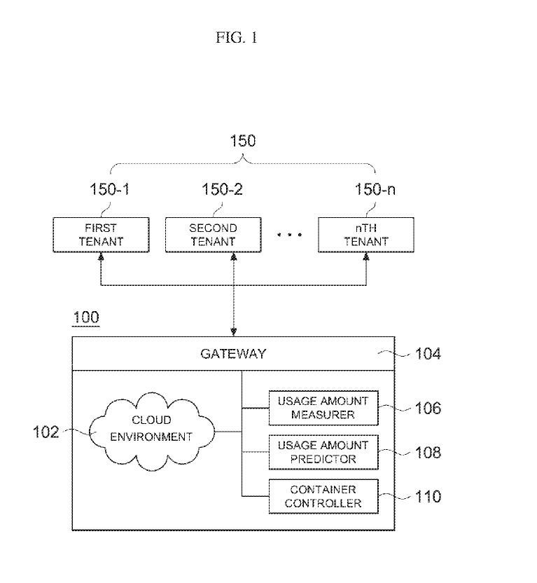

FIG. 1 is a block diagram showing a configuration of a multi-tenant-based service provision system 100 according to an embodiment of the present disclosure. As shown in FIG. 1, the multi-tenant-based service provision system 100 according to an embodiment of the present disclosure includes a cloud environment 102, a gateway 104, a usage amount measurer 106, a usage amount predictor 108, and a container controller 110.

In these embodiments, a container refers to a software provision technique for packaging an application intended to be executed and dependant objects (e.g., a library, a system tool, a runtime environment, etc.) needed to drive the application together and providing the package. Such a container does not include a kernel of an operating system, and is thus operated more quickly and rapidly and uses fewer resources than a conventional virtual machine. A relationship between a container and a container image is the same as a relationship between a process and an executable file. In other words, a case in which elements constituting a container are statically present in a storage is called a container image, and a case in which a corresponding container image is loaded into an actual memory and processed is called a container.

In these embodiments, the container image may include information regarding an available resource allocation amount. Here, a resource may be a combination of computing resources (e.g., a CPU, a memory, a hard disk, etc.) for running an application. Also, the resource may be an idle resource included in the multi-tenant-based service provision system 100. In these embodiments, an increase or decrease in usage of resources may indicate an increase or decrease in usage of elements constituting the resources. Also, a service processing rate (e.g., the number of processes per minute) corresponding to the container image may differ depending on a resource allocation amount for the container. In other words, the multi-tenant-based service provision system 100 according to an embodiment of the present disclosure may efficiently allocate resources of the system by distributing or collecting a container image.

The cloud environment 102 refers to a set of one or more servers for providing a cloud-based computing resource provision service to one or more tenants 150 connected thereto over a network. Here, the network may include the Internet, one or more local area networks, a wide area network, a cellular network, a mobile network, other kinds of networks, or a combination thereof. Also, the tenant 150 may be a unit (e.g., an individual or a company) that requests a service and receives the service.

The cloud environment 102 may simultaneously provide a service to a plurality of tenants 150. For example, the cloud environment 102 may provide a service to the tenant 150 in the form of software as a service (SaaS) on the basis of cloud computing. The embodiments of the present disclosure are not limited to a specific kind or form of service.

The cloud environment 102 may use a container image to provide a service. In detail, the cloud environment 102 may provide a service corresponding to an application stored in a container image by driving the container image. As an example, the cloud environment 102 may use a plurality of container images to provide a service. In this case, each of the container images may be configured to provide the same kind of service, but may have different resource allocation amounts.

The cloud environment 102 may provide a service within a range of resource allocation amounts of container images distributed by the container controller 110, which will be described below. The cloud images being distributed to the cloud environment 102 by the container controller 110 may refer to the container images being driven in the cloud environment 102 in the form of a process. That is, the cloud environment 102 may execute only the distributed container images, and the container images include resource allocation amounts. Accordingly, the number of resources that may be used by the cloud environment 102 to provide a service may be limited to the sum of the resource allocation amounts of the container images. Thus, it is possible to prevent resources being used by a service requested by any one of the tenants 150 from being used by the other tenants.

In the cloud environment 102, services requested by the tenants 150 may be logically distinct from each other. In detail, a logical area for each of the services of the tenants 150 may be present in the cloud environment 102. For example, the cloud environment 102 may include an area (e.g., a server allocated to each of the services of the tenants) corresponding to a first tenant 150-1, and a container image distributed to the area may be used to provide a service requested by the first tenant 150-1. That is, in the cloud environment 102, a container image distributed to the area of the first tenant 150-1 is not shared with a second tenant 150-2. The cloud environment 102 can prevent a fault that occurs in a specific container image from spreading to another tenant 150 by separately executing a container image for each of the tenants 150.

The gateway 104 is a module for connecting the plurality of tenants 150 to the cloud environment 102. In detail, the gateway 104 may receive a request for a service from the plurality of tenants 150 and route the received service request to a container corresponding to the service in the cloud environment 102. In other words, the gateway 104 may route a request for a service received from the tenant 150 to an area corresponding to the service, and the tenant 150 in the cloud environment 102. Here, the request for the service received from the tenant 150 may include a service type, a service request number, etc. The service request number may refer to a service processing rate, and the service processing rate may be, for example, the number of processes per minute. The service request number is associated with the above-described number of resources. For example, as the service request number increases, the necessary number of resources may increase.

The gateway 104 may delay processing the service requested by the tenants 150. In detail, when a container image needs to be additionally distributed to the cloud environment 102 by the container controller 110, which will be described below, the gateway 104 may delay the processing the requested service through flow control. According to an embodiment, when the sum of resource allocation amounts of the container images distributed to the cloud environment 102 is smaller than a predicted resource usage amount, the gateway 104 may delay processing the requested service. The gateway 104 may ensure a time needed for the container controller 110 to distribute the container image by delaying the processing of the service requested by the tenant 150. Thus, requested services may be provided by a container image that is newly adjusted.

When the number of requests received from tenant 150 exceeds a predetermined value, the gateway 104 may determine that a fault has occurred and may block the requests received from the tenant 150. In other words, when too many service requests are received, the gateway 104 may stop routing.

The usage amount measurer 106 may measure a resource usage amount used to provide a service requested in the cloud environment 102. In detail, the usage amount measurer 106 may measure a resource usage amount of a service for each of the plurality of tenants 150 in the cloud environment 102. That is, the usage amount measurer 106 may measure the resource usage amount for each of the plurality of tenants 150 and each of the services requested by the tenants 150. According to an embodiment, the usage amount measurer 106 may measure a resource usage amount every predetermined period of time (e.g., 1 day or 1 month).

Next, the usage amount predictor 108 may analyze the measured resource usage amount and predict a necessary resource usage amount. As an example, the usage amount predictor 108 may predict that a currently measured resource usage amount is a necessary resource usage amount, but is not limited thereto.

According to an embodiment, the usage amount predictor 108 may analyze a pattern of the resource usage amount during the predetermined period of time (e.g., 1 day or 1 month) on the basis of the measured resource usage amount. The pattern of the resource usage amount may include, for example, a pattern in which a section with a resource usage amount and a section without a resource usage amount are repeated, a pattern in which a resource usage amount gradually increases, an irregular pattern, a predictable pattern, etc.

The container controller 110 may manage container images provided for each service. In this case, container images corresponding to the same service may have various resource allocation amounts. In detail, the container controller 110 may adjust the number and types (e.g., the types of corresponding services or resource allocation amounts) of container images distributed to the cloud environment 102 according to a result of the prediction. That is, the container controller 110 may distribute container images for executing the services to the cloud environment 102 or collect container images distributed to the cloud environment 102.

In detail, when not enough container images are distributed to the cloud environment 102 as a result of the prediction result, the container controller 110 may distribute more container images to the cloud environment 102. According to an embodiment, when the sum of resource allocation amounts of the container images distributed to the cloud environment 102 is smaller than the predicted resource usage amount, the container controller 110 may distribute container images to the cloud environment 102.

Also, when some of the container images distributed to the cloud environment 102 according to the prediction result are unnecessary, the container controller 110 may collect unnecessary container images. According to an embodiment, when the sum of the resource allocation amounts of the container images distributed to the cloud environment 102 is greater than the predicted resource usage amount, the container controller 110 may collect some of the distributed container images.

The container controller 110 may distribute or collect container images according to the pattern of the resource usage amount that is analyzed during the predetermined period of time (e.g., 1 day or 1 month). In detail, the container controller 110 may be configured to automatically adjust the number and types of container image distributed to the cloud environment 102 on the basis of time. For example, when a throughput of the service requested by the first tenant 150-1 reaches a peak level at 9 o'clock and a throughput of the service requested by the second tenant 150-2 reaches a peak level at 11 o'clock, the container controller 110 may additionally distribute a container image to the first tenant 150-1 at 9 o'clock and may additionally distribute a container image to the second tenant 150-2 at 11 o'clock. When the distributed container images become unnecessary as times corresponding to the peak levels of the service throughputs of the first tenant 150-1 and the second tenant 150-2 elapse, the container controller 110 may collect the distributed container images.

As described above, the container controller 110 may distribute or collect container images according to the acquired pattern and may also distribute or collect container images in real time.

When many container images, which are associated with a service provided to the tenant 150, are distributed to the cloud environment 102, burdens on the tenant 150 and the gateway 104 configured to route the service increase. For example, when a plurality of container images having small resource allocation amounts are operated in response to a request for the same service, a routing load of the gateway 104 is increased more than when one container image having a large resource allocation amount is operated. A process of distributing or collecting container images will be described below in consideration of the number of container images and a resource allocation amount of each of the container images.

First, the container controller 110 may compare a resource usage amount of container images that are currently distributed to the cloud environment 102 with a predicted resource usage amount.

Next, when the sum of the resource allocation amounts of the distributed container images is smaller than the predicted resource usage amount, the container controller 110 may distribute container images to the cloud environment 102 on the basis of the number of container images associated with a resource requirement amount needed for the cloud environment 102. The resource requirement amount is the amount of resources that is additionally required to perform a task without a delay of an operational process in the cloud environment 102 and, for example, may be a difference between the predicted resource usage amount and the sum of the resource allocation amounts of the distributed container images. One or more container images associated with the resource requirement amount of the cloud environment 102 may be configured such that the sum of the corresponding resource allocation amounts is greater than or equal to the resource requirement amount. According to an embodiment, the container controller 110 may control the number of container images distributed to the cloud environment 102 in consideration of a resource allocation amount corresponding to each of the container images.

In detail, when the sum of the resource allocation amounts of the distributed container images is smaller than the predicted resource usage amount, the container controller 110 may distribute a container image having the greatest resource allocation amount within a range of the difference between the sum of the resource allocation amounts and the predicted resource usage amount to the cloud environment 102. That is, the container controller 110 can prevent an unnecessary increase in the number of containers by distributing a container image having the greatest resource allocation amount within a range of resources that are needed.

For example, it is assumed that the container controller 110 includes a plurality of container images having resource allocation amounts of 2, 5, and 10. In this case, when the resource usage amount predicted by the usage amount predictor 108 is 8, the container controller 110 may first distribute the container image having the resource allocation amount of 5 to the cloud environment 102. The container controller 110 may distribute container images by repeating the above-described process. In the aforementioned example, the container controller 110 may additionally distribute the container image having the resource allocation amount of 2. In this case, the sum of the resource allocation amounts of the container images distributed to the cloud environment 102 may be 7.

Next, when the difference between the predicted resource usage amount and the sum of the resource allocation amounts of the container images distributed to the cloud environment 102 is smaller than the smallest resource allocation amount among the resource allocation amounts corresponding to the container images, the container image having the smallest resource allocation amount may be distributed to the cloud environment 102. That is, when the sum of the resource allocation amounts of the distributed container images exceeds the predicted resource usage amount although any of the container images is additionally distributed, the container controller 110 may distribute the container image having the smallest resource allocation amount to the cloud environment 102. In the aforementioned example, the container controller 110 may additionally distribute the container image having the resource allocation amount of 2. In this case, the sum of the resource allocation amounts of the container images distributed to the cloud environment 102 may be 9. Accordingly, the container controller 110 can minimize resource wastage in comparison to the predicted resource usage amount.

On the other hand, when the sum of the resource allocation amounts of the distributed container images is greater than the predicted resource usage amount and there is a container image having a resource allocation amount smaller than the difference between the predicted resource usage amount and the sum of the resource allocation amounts, the container controller 110 may collect a container image having the smallest resource allocation amount among the distributed container images. It is possible to save as many resources as resource allocation amounts of unnecessary container images by removing the unnecessary container images from the cloud environment 102.

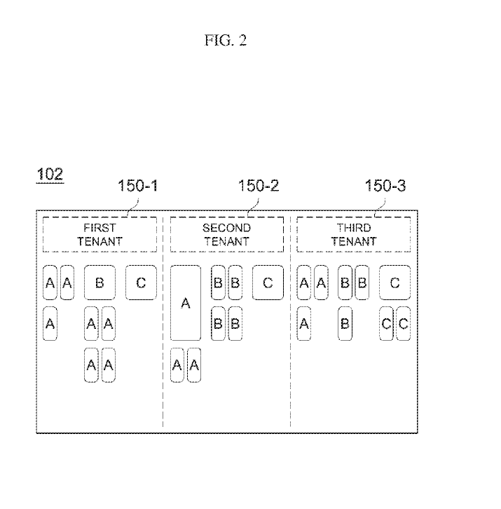

FIG. 2 is an example diagram showing a structure of the cloud environment 102 according to an embodiment of the present disclosure. As shown in FIG. 2, the cloud environment 102 may logically distinguish areas corresponding to services of the tenants 150 from each other. As an example, the areas in the cloud environment 102 may refer to a server for each of the services allocated to each of the tenants 150.

In detail, the cloud environment 102 may include an area corresponding to the first tenant 150-1, and a container image distributed to the area may be used to provide a service requested by the first tenant 150-1. That is, in the cloud environment 102, the container image distributed to the area of the first tenant 150-1 may not be shared with the second tenant 150-2. The cloud environment 102 can prevent a fault that occurs in a specific container image from spreading to another tenant 150 by separately executing a container image for each of the tenants 150.

Referring to FIG. 2, container images associated with a service A, a service B, and a service C are distributed to an area corresponding to the first tenant 150-1. Here, a size of each container box shown in FIG. 2 indicates a resource allocation amount of a corresponding container image. For example, one container image having a large resource allocation amount and two container images having a small resource allocation amount, all of which are associated with the service A, may be distributed to an area corresponding to the second tenant 150-2. Also, four container images having a small resource allocation amount, which are associated with the service B, may be distributed to the area corresponding to the second tenant 150-2. Also, one container image having a medium resource allocation amount, which is associated with the service C, may be distributed to the area corresponding to the second tenant 150-2.

The cloud environment 102 may provide a service by using the container images distributed for each service of each of the tenant 150. In this case, the available amount of resources may be determined by the resource allocation amounts of the distributed container images.

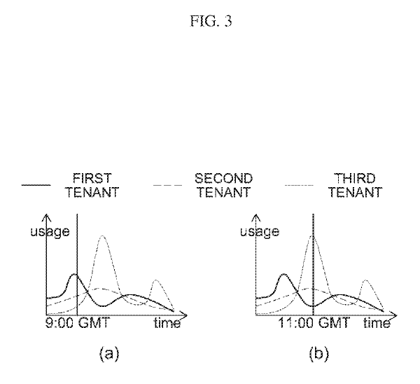

FIG. 3 is an example graph of a resource usage amount measured by the usage amount measurer 106 according to an embodiment of the present disclosure. The graph shown in FIG. 3 indicates resource usage amounts of a plurality of tenants with respect to specific services (e.g., the service A or the service B). Here, the tenant 150 having a resource usage amount denotes that resources are used to drive a container image in the cloud environment 102 according to a request of the tenant 150.

First, referring to FIG. 3a, it can be seen that a resource usage amount of the first tenant 150-1 is highest at 9 o'clock during a day. As an example, as a result of analyzing a measured resource usage amount, the usage amount predictor 108 may predict that the resource usage amount of the first tenant 150-1 will be highest at 9 o'clock even during another day. Subsequently, the container controller 110 may additionally distribute a container image to the cloud environment 102 at 9 o'clock every day. Also, after 9 o'clock, the container controller 110 may collect the container image distributed to the cloud environment 102.

Next, referring to FIG. 3b, it can be seen that a resource usage amount of a third tenant is highest at 11 o'clock during a day. As an example, as a result of analyzing a measured resource usage amount, the usage amount predictor 108 may predict that the resource usage amount of the third tenant will be highest at 11 o'clock even during another day. Subsequently, the container controller 110 may additionally distribute a container image to the cloud environment 102 at 11 o'clock every day. Also, after 11 o'clock, the container controller 110 may collect the container image distributed to the cloud environment 102.

As described above, the container controller 110 may analyze a resource usage amount in real time to distribute or collect container images, or may also automatically distribute or collect container images every period of time (e.g., 1 day or 1 month). Accordingly, it is possible to quickly and flexibly react to a demand of resources that rapidly changes according to a request of the tenant 150.

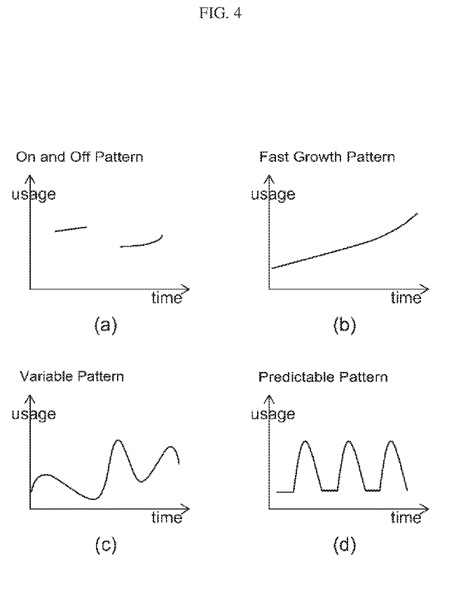

FIG. 4 is a graph showing an example pattern of a measured resource usage amount according to an embodiment of the present disclosure. The graph shown in FIG. 4 indicates resource usage amounts of a specific tenant (e.g., the first tenant 150-1) with respect to a specific service (e.g., the service A).

Referring to the graph of FIG. 4a, it can be seen that an on and off pattern appears in which a section with a resource usage amount and a section without a resource usage amount are repeated. That is, the pattern may be a case in which resources are used only at specific times but not at other times. According to an embodiment, in this case, the container controller 110 may distribute a container image having a large resource allocation amount while resources are used. Also, the container controller 110 may collect the container image while resources are not used. Accordingly, the container controller 110 may distribute or collect a small number of container images and may also reduce the amount of load generated when the gateway 104 performs routing.

Referring to the graph of FIG. 4b, it can be seen that a fast growth pattern appears in which a resource usage amount increases. That is, the container controller 110 may continuously distribute container images to the cloud environment 102 during a predetermined time. According to an embodiment, in this case, the container controller 110 may distribute container images having a large source allocation amount until the resource usage amount starts to increase and then may additionally distribute container images having a small source allocation amount. Accordingly, the container controller 110 may increase resource efficiency and also enhance service quality by calculating an optimal amount of resources.

Referring to the FIG. 4c, it can be seen that a variable pattern appears in which a resource usage amount is irregular. According to an embodiment, when a resource usage amount irregularly increases or decreases, a container image having a small resource allocation amount may be distributed or collected. The container controller 110 may flexibly calculate resources by distributing or collecting containers having a small resource allocation amount in response to a frequent increase or decrease in resource usage amount.

Referring to the FIG. 4d, it can be seen that a predictable pattern appears in which a resource usage amount is predictable. In detail, the graph of FIG. 4d may show a pattern in which a certain resource usage amount is regularly measured and a certain increase and decrease in resource usage amount are repeated. According to an embodiment, the container controller 110 may distribute or collect a container image having a large resource allocation amount in response to a guaranteed amount of resources and an increased or decreased amount of the resources.

Accordingly, the container controller 110 may achieve all of an increase in resource efficiency and a reduction in routing load of the gateway 104 by appropriately distributing or collecting container images having different resource allocation amounts depending on a service.

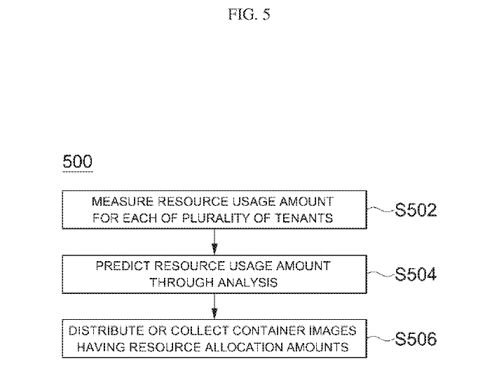

FIG. 5 is a flowchart 500 illustrating a multi-tenant-based service provision method according to an embodiment of the present disclosure. The method has been described as having a plurality of steps in the shown flowchart. However, at least some of the steps may be performed in an exchanged order, performed in combination with another step, omitted, divided into sub-steps, or performed in addition to one or more steps that are not shown.

First, the usage amount measurer 106 may measure a resource usage amount of a service provided for each of the plurality of tenants 150 in the cloud environment 102 (S502). The gateway 104 may receive a request for the service from the plurality of tenants 150 and route the received service request in the cloud environment 102 to the tenant 150 and a container corresponding to the service.

Next, the usage amount predictor 108 may analyze the measured resource usage amount and predict a necessary resource usage amount (S504). In this case, the usage amount predictor 108 may analyze a pattern of the resource usage amount during a predetermined period of time.

Next, according to a result of the prediction, the container controller 110 may distribute container images for executing the service to the cloud environment 102 or collect the container images distributed to the cloud environment 102 (S506). To this end, the container controller 110 may have a plurality of container images each including information regarding an available resource allocation amount. In detail, when the sum of resource allocation amounts of the container images distributed to the cloud environment 102 is smaller than the predicted resource usage amount, the container controller 110 may distribute the container images to the cloud environment 102. Also, the container controller 110 may distribute the container images to the cloud environment 102 or collect the container images distributed to the cloud environment 102 according to a pattern analyzed during a predetermined period of time.

According to an embodiment, when the sum of resource allocation amounts of the container images distributed to the cloud environment 102 is smaller than the predicted resource usage amount, the container controller 110 may distribute container images having the largest resource allocation amount to the cloud environment 102 within a range of a difference between the sum of resource allocation amounts to the predicted resource usage amount.

According to an embodiment, when the difference between the predicted resource usage amount and the sum of resource allocation amounts of the container images distributed to the cloud environment 102 is smaller than the smallest resource allocation amount among resource allocation amounts corresponding to the container images, the container controller 110 may distribute the container image having the smallest resource allocation amount to the cloud environment 102.

According to an embodiment, when the sum of the resource allocation amounts of the container images distributed to the cloud environment 102 is greater than the predicted resource usage amount, the container controller 110 may collect the container images having the smallest resource allocation amount among the distributed container images.

When the number of requests for a service received from the tenant 150 exceeds a predetermined value, the gateway 104 may determine that a fault has occurred and may stop the routing.

Also, when the sum of resource allocation amounts of the container images distributed to the cloud environment 102 is smaller than the predicted resource usage amount, the gateway 104 may perform load balancing of the requested service.

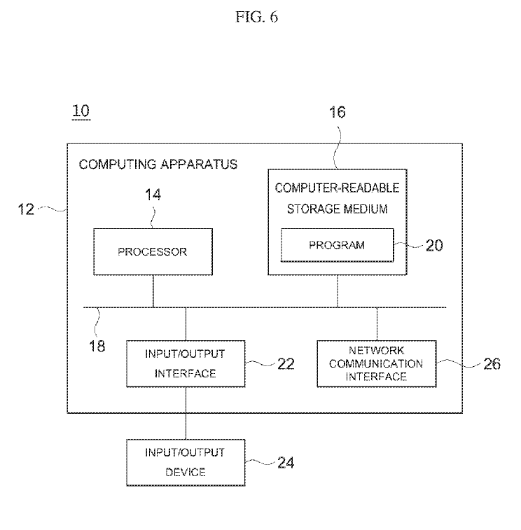

FIG. 6 is a block diagram illustrating a computing environment 10 including a computing apparatus that is suitable to be used according to example embodiments. In the shown embodiment, each component may have a function and capability different from the following description, and an additional component may be included other than those in the following description.

The computing environment 10 shown therein includes a computing apparatus 12. In an embodiment, the computing apparatus 12 may be the multi-tenant-based service provision system 100.

The computing apparatus 12 includes at least one processor 14, a computer-readable storage medium 16, and a communication bus 18. The processor 14 may enable the computing apparatus 12 to operate according to the aforementioned example embodiment. For example, the processor 14 may execute one or more programs stored in the computer-readable storage medium 16. The one or more programs may include one or more computer executable instructions which may be configured to enable the computing apparatus 12 to perform operations according to an example embodiment when they are executed by the processor 14.

The computer-readable storage medium 16 is configured to store computer-executable instructions, program codes, program data, and/or other suitable forms of information. The program 20 stored in the computer-readable storage medium 16 includes a set of instructions that are executable by the processor 14. In an embodiment, the computer-readable storage medium 16 may be a memory (a volatile memory such as a random access memory, a non-volatile memory, or an appropriate combination thereof), one or more magnetic disk storage devices, optical disk storage devices, flash memory devices, other forms of storage media that may be accessed by the computing apparatus 12 and are configured to store desired information, or a suitable combination thereof.

The communication bus 18 connects the processor 14, the computer-readable storage medium 16, and other various components of the computing apparatus 12 to one another.

The computing apparatus 12 may also include one or more input/output interfaces 22 that provide an interface for one or more input/output devices 24 and one or more network communication interfaces 26. The input/output interfaces 22 and the network communication interfaces 26 are connected to the communication bus 18. The input/output devices 24 may be connected to other components of the computing apparatus 12 through the input/output interfaces 22. For example, the input/output devices 24 may include input devices such as a pointing device (a mouse or a track pad), a keyboard, a touch input device (a touch pad or a touch screen), a voice or sound input device, and various kinds of sensor devices, photographing devices, and/or output devices such as a display device, a printer, a speaker, and/or a network card. For example, the input/output devices 24 may be included in the computing apparatus 12 as components that form the computing apparatus 12, and may be connected to the computing apparatus 12 as separate devices distinct from the computing apparatus 12.

According to embodiments of the present disclosure, it is possible to prevent system resources from being monopolized by a specific tenant by providing a service using container images having resource allocation amounts in a cloud environment.

Also, according to embodiments of the present disclosure, when a fault associated with a specific container occurs, it is possible to prevent the fault from affecting other tenants by providing a service in a cloud environment in units of a container.

Also, according to an embodiment of the present disclosure, it is possible to reduce resource wastage and decrease a load generated when a gateway routes a service because the multi-tenant-based service provision system controls the number and types of container images having different resource allocation amounts with respect to the same service.

Although example embodiments of the present disclosure have been described in detail, those skilled in the art should understand that various changes may be made without departing from the spirit or scope of the present disclosure. Thus, the scope of the present disclosure is to be determined by the following claims and their equivalents, and is not restricted or limited by the foregoing detailed description.

What is claimed is:

1. A multi-tenant-based service provision system comprising:
at least one processor configured to implement:
a usage amount measurer configured to measure a resource usage amount of a service provided for a plurality of tenants in a cloud environment;
a usage amount predictor configured to analyze the measured resource usage amount and predict a necessary resource amount; and
a container controller configured to control distribution of a plurality of container images for executing the service to the cloud environment based on the necessary resource amount, the plurality of container images each including information regarding a corresponding available resource allocation amount.

2. The multi-tenant-based service provision system of claim 1, wherein the container controller is further configured to allocate additional container images of the plurality of container images to the cloud environment based on a sum of resource amounts of allocated container images of the plurality of container images distributed to the cloud environment being smaller than the predicted necessary resource amount.

3. The multi-tenant-based service provision system of claim 1, wherein the container controller is further configured to allocate a number of container images from among the plurality of container images to the cloud environment based on a sum of resource amounts of allocated container images of the plurality of container images distributed to the cloud environment being smaller than the predicted necessary resource amount, the number of container images to be allocated corresponding to a resource requirement amount needed for the cloud environment.

4. The multi-tenant-based service provision system of claim 1, wherein the at least one processor is further configured to implement a gateway configured to receive requests for the service from the plurality of tenants and route the received requests to a container corresponding to the service in the cloud environment.

5. The multi-tenant-based service provision system of claim 4, wherein the gateway is further configured to determine that a fault has occurred and stop the routing based on a number of the requests received for the service exceeding a predetermined value.

6. The multi-tenant-based service provision system of claim 4, wherein the gateway is further configured to delay processing a requested service based on a sum of resource amounts of allocated container images of the plurality of container images distributed to the cloud environment being smaller than the predicted necessary resource amount.

7. The multi-tenant-based service provision system of claim 1, wherein the usage amount predictor is further configured to analyze a pattern of the resource usage based on the resource usage amount measured during a predetermined period of time; and
wherein the container controller is further configured to control distribution of the plurality of container images to the cloud environment based on the necessary resource amount and the pattern of the resource usage during the predetermined period of time.

8. A multi-tenant-based service provision method performed by a service including one or more processors and a memory configured to store one or more programs executed by the one or more processors, the multi-tenant-based service provision method comprising:
measuring a resource usage amount of the service provided for a plurality of tenants in a cloud environment;
analyzing the measured resource usage amount and predicting a necessary resource amount; and
controlling distribution of a plurality of container images for executing the service to the cloud environment based on the necessary resource amount, the plurality of container images each including information regarding a corresponding available resource allocation amount.

9. The multi-tenant-based service provision method of claim 8, wherein the controlling distribution of the plurality of container images comprises allocating additional container images of the plurality of container images to the cloud environment based on a sum of resource amounts of allocated container images of the plurality of container images distributed to the cloud environment being smaller than the predicted necessary resource amount.

10. The multi-tenant-based service provision method of claim 8, wherein the controlling distribution of the plurality of container images comprises allocating a number of container images from among the plurality of container images to the cloud environment based on a sum of resource amounts of allocated container images of the plurality of container images distributed to the cloud environment being smaller than the predicted necessary resource amount, the number of container images to be allocated corresponding to a resource requirement amount needed for the cloud environment.

11. The multi-tenant-based service provision method of claim 8, wherein the multi-tenant-based service provision method further comprise receiving requests for the service from the plurality of tenants and routing the received requests to a container corresponding to the service in the cloud environment before measuring the resource usage amount.

12. The multi-tenant-based service provision method of claim 11, wherein the routing comprises determining that a fault has occurred and stopping the routing based on a number of the received requests for the service exceeding a predetermined value.

13. The multi-tenant-based service provision method of claim 11, wherein the routing comprises delay processing a requested service based on a sum of resource amounts of allocated container images of the plurality of container images distributed to the cloud environment being smaller than the predicted necessary resource amount.

14. The multi-tenant-based service provision method of claim 8, wherein the predicting comprise analyzing a pattern of the resource usage amount based on the resource usage amount measured during a predetermined period of time; and
wherein the controlling the distribution of the plurality of container images comprises distributing container images to the cloud environment or collecting container images distributed to the cloud environment based on the necessary resource amount and the pattern of the resource usage during the predetermined period of time.

15. A non-transitory computer readable recording medium having embodied thereon a program, which when executed by a processor of a multi-tenant based service provision system causes the multi-tenant based service provision system to execute a method including:
measuring a resource usage amount of the service provided for a plurality of tenants in a cloud environment;
analyzing the measured resource usage amount and predicting a necessary resource amount; and
controlling distribution of a plurality of container images for executing the service to the cloud environment based on the necessary resource amount, the plurality of container images each including information regarding a corresponding available resource allocation amount.

16. The non-transitory computer readable recording medium of claim 15, wherein the controlling distribution of the plurality of container images comprises allocating additional container images of the plurality of container images to the cloud environment based on a sum of resource amounts of allocated container images of the plurality of container images distributed to the cloud environment being smaller than the predicted necessary resource amount.

17. The non-transitory computer readable recording medium of claim 15, wherein the controlling distribution of the plurality of container images comprises allocating a number of container images from among the plurality of container images to the cloud environment based on a sum of resource amounts of allocated container images of the plurality of container images distributed to the cloud environment being smaller than the predicted necessary resource amount, the number of container images to be allocated corresponding to a resource requirement amount needed for the cloud environment.

18. The non-transitory computer readable recording medium of claim 15, wherein the multi-tenant-based service provision method further comprise receiving requests for the service from the plurality of tenants and routing the received requests to a container corresponding to the service in the cloud environment before measuring the resource usage amount.

19. The non-transitory computer readable recording medium of claim 18, wherein the routing comprises determining that a fault has occurred and stopping the routing based on a number of the received requests for the service exceeding a predetermined value.

20. The non-transitory computer readable recording medium of claim 18, wherein the routing comprises delay processing a requested service based on a sum of resource amounts of allocated container images of the plurality of container images distributed to the cloud environment being smaller than the predicted necessary resource amount.
